(19) United States
(12) Patent Application Publication
(10) Pub. No.: US 2026/0025292 A1
(43) Pub. Date: Jan. 22, 2026

(54) TRANSMITTING/RECEIVING DEVICE FOR A SUBSCRIBER STATION OF A SERIAL BUS SYSTEM, AND METHOD FOR COMMUNICATING BY MEANS OF DIFFERENTIAL SIGNALS IN A SERIAL BUS SYSTEM

(71) Applicant: Robert Bosch GmbH, Stuttgart (DE)

(72) Inventors: Arthur Mutter, Neuhausen (DE); Steffen Walker, Reutlingen (DE)

(21) Appl. No.: 19/261,541

(22) Filed: Jul. 7, 2025

(30) Foreign Application Priority Data
Jul. 18, 2024 (DE) 10 2024 206 781.4

(51) Int. Cl. H04L 12/40

(52) U.S. Cl. CPC H04L 12/40006

(57) ABSTRACT

A transmitting/receiving device for a subscriber station of a serial bus system. The transmitting/receiving device has a receiver module for serially receiving differential signals from a bus and for generating a digital reception signal for a communication control device, an operating mode control module for switching the receiver module between a first operating mode and a second operating mode so that the receiver module is configured to generate the digital reception signal in the first operating mode based on differential signals generated using a first physical layer and in the second operating mode based on differential signals generated using a second physical layer, and a first evaluation block for evaluating whether a predetermined number of falling edges and/or rising edges occurs serially in the digital reception signal and whether the reception signal that comprises the edges that occurred is based on differential signals generated using the second physical layer.

### CROSS REFERENCE

The present application claims the benefit under 35 U.S.C. § 119 of Germany Patent Application No. DE 10 2024 206 781.4 filed on Jul. 18, 2024, which is expressly incorporated herein by reference in its entirety.

### FIELD

The present invention relates to a transmitting/receiving device for a subscriber station of a serial bus system and to a method for communicating by means of differential signals in a serial bus system.

### BACKGROUND INFORMATION

Serial bus systems have a bus to which subscriber stations (nodes) are connected by means of a transmitting/receiving device in order to communicate with one another via the bus. The transmitting/receiving device is also called a transceiver. During communication, data are exchanged between the subscriber stations, which are, for example, sensors, control units in a vehicle, or a technical production plant, etc. For data transmission in serial bus systems, there are various communication standards or data transmission protocols, such as CAN, also known as the controller area network. In CAN bus systems, in an arbitration phase, the subscriber stations on the bus negotiate (arbitration) which of the subscriber stations may transmit their message onto the bus in the subsequent data phase and has exclusive access to the bus during this process. For in-vehicle communication, vehicle manufacturers, in particular automotive manufacturers, want ever higher bit rates for transmitting data between the technical devices in the vehicle. For this purpose, bus systems or communication buses are preferred over point-to-point connections for financial reasons.

For example, for such higher bit rates, CAN FD may be used, which is standardized in the international standard ISO/DIS 11898-1:2024. CAN FD is used by most users in a first step with a 2 Mbit/s data bit rate and a 500 kbit/s arbitration bit rate in the vehicle. New, so-called SIC transmitting/receiving devices (transceivers) make it possible to use CAN FD with up to 8 Mbit/s. With CAN FD, up to 64 bytes can be transmitted per message in the data phase.

For even higher data bit rates than CAN FD, CAN XL is available now. CAN XL is also specified in the international standard ISO/DIS 11898-1:2024. CAN XL supports up to 20 Mbit/s and payload data lengths of up to 2048 bytes in the data phase. The use of CAN XL in real-world products is currently underway.

For transmission rates over 8 Mbit/s, the physical layer in CAN XL must_be switched to a different physical layer in the data phase than in the arbitration phase and in CAN FD. In CAN XL, the data phase is also referred to as the communication phase FAST. The physical layer corresponds to the bit transmission layer or layer 1 of the conventional OSI (Open Systems Interconnection) model.

Generally, CAN XL is compatible with CAN FD. It is therefore possible in a CAN bus system to operate subscriber stations that do not all use the same communication standard for CAN. That is to say, in addition to CAN XL subscriber stations, at least one subscriber station that transmits CAN FD messages may be present, for example. Upon receipt of such a CAN FD message, the CAN XL subscriber stations adjust accordingly and can thus also receive the CAN FD message correctly.

In order to keep the error rate low in CAN XL and thus to maximize the possible transmission rate in the bus system, it is important that a subscriber station that is newly added to the communication on the bus detects the communication phase in which communication is currently taking place on the bus. A high-bandwidth comparator is to be used for this purpose.

It is problematic that the comparator provided with CAN XL for detecting the communication phase FAST incorrectly also detects low unwanted voltage difference levels that occur during operation of the bus system. Such undesired voltage difference levels may be due to non-idealities in the bus system. Such non-idealities in the system are, for example, reflections in the network, which lead to unwanted errors, in particular glitches in the reception signal, and/or a so-called common-to-differential mode conversion, in which voltage fluctuations on the bus are converted into differential signals at the input of the comparator, and/or interference signals coupling asymmetrically into the two bus lines.

As a result, the error rate in the bus system may increase, which ultimately decreases the transmittable bit rate over the bus of the bus system.

### SUMMARY

An object of the present invention is therefore to provide a transmitting/receiving device for a subscriber station of a serial bus system and a method for communicating by means of differential signals in a serial bus system, which solve the aforementioned problems. In particular, a transmitting/receiving device for a subscriber station of a serial bus system and a method for communicating by means of differential signals in a serial bus system are to be provided, which, when communicating by means of CAN XL via a bus of the bus system, make reliable and, if possible, error-free reception of signals from the bus possible with minimal effort and thus cost-effectively, even in the case of external interference on the bus.

The object may be achieved by a transmitting/receiving device for a subscriber station of a serial bus system with certain features of the present invention. According to an example embodiment of the present invention, the transmitting/receiving device has a receiver module for serially receiving differential signals from a bus of the bus system and for generating a digital reception signal for a communication control device, an operating mode control module for switching the receiver module between a first operating mode and a second operating mode so that the receiver module is configured to generate the digital reception signal in the first operating mode based on differential signals generated by means of a first physical layer and in the second operating mode based on differential signals generated by means of a second physical layer, which is different from the first physical layer, and a first evaluation block for evaluating whether a predetermined number of falling edges and/or rising edges occurs serially in the digital reception signal and whether the reception signal that comprises the edges that occurred is based on differential signals generated by means of the second physical layer, wherein the operating mode control module is also configured to set the transmitting/receiving device for its subsequent operation on the basis of the evaluation result of the first evaluation block.

According to an example embodiment of the present invention, the described transmitting/receiving device is capable of detecting its operating mode in the operation of the bus system itself. As a result, the described transmitting/receiving device can deduce whether or not the transmitting/receiving device is operating in a pure SIC bus system, and adjust accordingly in order to maximize the robustness of the transmission in the bus system and/or the power input into the transmitting/receiving device.

The transmitting/receiving device for CAN XL is in particular a SIC XL transceiver, which can itself detect whether the SIC XL transceiver is used in a CAN bus system with or without operating mode switching of the transmitting/receiving device. During operating mode switching, switching occurs between a slow operating mode (SIC), in which differential signals are generated by means of a first physical layer on the bus of the bus system, and a fast operating mode (FAST or XL), in which differential signals are generated by means of a second physical layer on the bus of the bus system and, optionally, with a higher bit rate than in the slow operating mode (SIC). The operating mode switching of the transmitting/receiving device may also be referred to as transceiver mode switching.

Due to this embodiment of the present invention, the transmitting/receiving device described can, for example, always adjust such that an additional reception threshold is switched on or off depending on whether the bus system is a pure SIC bus system or not.

The embodiment of the transmitting/receiving device of the present invention described above also allows it to be operated in pure SIC bus systems, in which only one physical layer is used, with a minimum error rate and thus highest robustness.

In addition, by switching off the unneeded comparator at least temporarily in a pure SIC bus system, the power input and thus the consumption of electrical energy is also reduced in comparison to a conventional CAN XL transmitting/receiving device.

This eliminates the need for a manual downgrade from a SIC XL transmitting/receiving device to a SIC transmitting/receiving device, in which the SIC XL transmitting/receiving device is permanently switched to the SIC operating mode via one-time programmable (OTP) memory or by metal mask or other methods during production. This avoids large administrative burden, which entails a lot of time and high costs.

In addition, the described transmitting/receiving device of the present invention saves the vehicle manufacturer from replacing the transmitting/receiving device (transceiver) if a change of a microcontroller of the subscriber station is made from a microcontroller that can transmit and evaluate CAN FD messages to a microcontroller that can transmit and evaluate CAN XL messages. This also eliminates any effort involved in testing and releasing the replaced transmitting/receiving device on the bus system.

The transmitting/receiving device described can thus be used for operation only in the SIC operating mode or for selective operation in the SIC operating mode or the XL operating mode, in which operation the transmitting/receiving device is switched to the SIC operating mode or the fast operating mode of CAN XL. This saves not only resources in development_but also resources in production and improves the technical sustainability and opportunities for further development of the transmitting/receiving device.

Overall, the transmitting/receiving device of the present invention described above helps to make the bus system at data rates of selectively up to 20 Mbit/s and data packets of selectively up to 2048 bytes in a message more cost-efficient and still to make robust or reliable CAN communication possible.

Advantageous further embodiments of the transmitting/receiving device are disclosed herein.

According to an example embodiment of the present invention, the operating mode control module may also be configured to set the receiver module for its subsequent operation on the basis of the evaluation result of the first evaluation block such that, regardless of a change in communication phases of the differential signals for a message on the bus, the receiver module remains switched to the first operating mode and is not switched to the second operating mode, and that a receiver circuit of the receiver module is switched off, which receiver circuit is configured with a lower reception threshold for evaluating the differential signals than a reception threshold used by a receiver circuit of the receiver module for generating the reception signal.

According to an example embodiment of the present invention, the operating mode control module may be configured to switch the transmitting/receiving device to the first operating mode for its subsequent operation if the predetermined number of falling edges and/or rising edges occurs and the digital reception signal that comprises the edges that occurred is based on differential signals not generated by means of the second physical layer.

The operating mode control module may be configured, if a number less than or equal to the predetermined number of falling edges and/or rising edges occurs and/or the digital reception signal that comprises the edges that occurred is based on differential signals generated by means of the second physical layer, to set the transmitting/receiving device for its subsequent operation such that the operating mode control module switches from the first operating mode to the second operating mode if, in a message (46) transmitted via the bus by means of the differential signals, a change from a first communication phase to a second communication phase of the message is signaled by switching the physical layer.

It is possible that the first evaluation block is configured to evaluate whether a predetermined number of falling edges or rising edges occurs serially in the digital reception signal, wherein the predetermined number is a natural number and is in a range of N=12 to N=20.

Alternatively, it is possible that the first evaluation block is configured to evaluate whether a predetermined number of falling edges and rising edges occurs serially in the digital reception signal, wherein the predetermined number is a natural number and is in a range of N=30 to N=40.

The at least one evaluation block may also be configured to evaluate, in the reception signal, the pulse time of pulses delimited by a rising edge and a falling edge or delimited by a falling edge and a rising edge.

According to one example embodiment of the present invention, the at least one evaluation block is configured to count edges in the reception signal for the predetermined number only if pulses delimited by a rising edge and a falling edge or delimited by a falling edge and a rising edge have a minimum pulse time.

According to one example embodiment of the present invention, the at least one evaluation block is also configured to evaluate, in the reception signal, the interval between pulses delimited by a rising edge and a falling edge or delimited by a falling edge and a rising edge. In this case, the at least one evaluation block may be configured to count edges in the reception signal for the predetermined number only if the reception signal contains a minimum interval between two pulses delimited by a rising edge and a falling edge or delimited by a falling edge and a rising edge.

It is possible that the first evaluation block performs its evaluation if the receiver module is switched to the first operating mode and the transmitting/receiving device has also been switched on again or attempts after an error to integrate into the communication on the bus, wherein a receiver circuit configured to receive the differential signals generated by means of a second physical layer is switched off after the operating mode control module has set the receiver module for its subsequent operation on the basis of the evaluation result of the first evaluation block.

According to an example embodiment of the present invention, the transmitting/receiving device described above may also comprise a transmitter module for serially transmitting onto the bus the differential signals based on a digital transmission signal generated by a communication control device, which transmission signal can have a first_bit time in a first communication phase and a second bit time, which is shorter than the first_bit time, in a second communication phase, wherein the transmitter module is settable to transmit the differential signals onto the bus in the second communication phase by means of the first physical layer or the second physical layer (452_P).

According to an example embodiment of the present invention, the transmitting/receiving device described above may also comprise a second evaluation block for evaluating the transmission signal with respect to the occurrence of pulse-width-modulated symbols, wherein the operating mode control module is configured to set the receiver module for its subsequent operation on the basis of the evaluation result of the first evaluation block. In this case, the operating mode control module may be configured to switch the receiver module for its subsequent operation to the second operating mode if the second evaluation block has evaluated that at least one pulse-width-modulated symbol has occurred in the transmission signal.

According to an example embodiment of the present invention, the transmitting/receiving device described above may be part of a subscriber station for a serial bus system, which subscriber station also comprises a communication control device configured, in the first communication phase of a frame for a message to be transmitted on the bus, to negotiate with at least one other subscriber station of the bus system as to which of the subscriber stations gains at least temporarily exclusive, conflict-free access to the bus in a subsequent second communication phase.

At least two subscriber stations may be part of a bus system, which also comprises a bus, wherein the at least two subscriber stations are connected to one another such that they can communicate serially with one another, and wherein at least one of the at least two subscriber stations is a subscriber station described above and is configured for communication according to CAN XL.

The aforementioned object is also achieved by a method for communicating by means of differential signals in a serial bus system according to the present invention. According to an example embodiment of the present invention, the method is carried out_by means of a transmitting/receiving device described above, wherein the transmitting/receiving device has a receiver module, an operating mode control module, and a first evaluation block, and wherein the method comprises the steps of serially receiving, by means of a receiver module, differential signals from a bus system for generating a digital reception signal for a communication control device, wherein the receiver module is switchable between a first operating mode and a second operating mode by means of an operating mode control module so that the receiver module is configured to generate the digital reception signal in the first operating mode based on differential signals generated by means of a first physical layer and in the second operating mode based on differential signals generated by means of a second physical layer, which is different from the first physical layer; evaluating, by means of a first evaluation block, whether a predetermined number of falling edges and/or rising edges occurs serially in the digital reception signal and whether the reception signal that comprises the edges that occurred is based on differential signals generated by means of the second physical layer; and setting, by means of the operating mode control module, the transmitting/receiving device for its subsequent operation on the basis of the evaluation result of the first evaluation block.

The method of the present invention offers the same advantages as those mentioned above with respect to the transmitting/receiving device of the present invention.

Other possible implementations of the present invention also include not explicitly mentioned combinations of features or embodiments described above or below with respect to the exemplary embodiments of the present invention. A person skilled in the art will also add individual aspects as improvements or additions to the particular basic form of the present invention, in view of the disclosure herein.

### BRIEF DESCRIPTION OF THE DRAWINGS

The present invention is described in more detail below with reference to the figures and on the basis of exemplary embodiments.

FIG. 1 shows a simplified block diagram of a bus system according to a first exemplary embodiment of the present invention.

FIG. 2 shows the format of CAN FD frames according to the aforementioned standard ISO 11898-1:2015 for a message that can be transmitted by a transmitting/receiving device for a subscriber station of the bus system according to the first exemplary embodiment of the present invention.

FIG. 3 shows the format of CAN XL frames according to the standard ISO/DIS 11898-1:2023 for a message that can be transmitted by a transmitting/receiving device for a subscriber station of the bus system according to the first exemplary embodiment as an alternative to the CAN FD frame of FIG. 2.

FIG. 4 shows a simplified schematic block diagram of a subscriber station of the bus system according to the first exemplary embodiment of the present invention.

FIG. 5 shows a time profile of a digital transmission signal during operation of the bus system at the subscriber station, which is connected to the same bus of the bus system with at least one other subscriber station.

FIG. 6 shows a time profile of bus signals CAN_H and CAN_L at the subscriber station according to the first exemplary embodiment of the present invention.

FIG. 7 shows a time profile of a differential voltage VDIFF of the bus signals CAN_H and CAN_L at the subscriber station according to the first exemplary embodiment of the present invention.

FIG. 8 shows a time profile of a digital reception signal generated by the subscriber station from a signal received from the bus, according to the present invention.

FIG. 9 shows an example of the ideal time profile of bus signals CAN_H, CAN_L, which are transmitted onto a bus of the bus system by subscriber stations of the bus system for the message of FIG. 3.

FIG. 10 shows the time profile of a differential voltage VDIFF, which forms on the bus of the bus system as a result of the bus signals of FIG. 9.

FIG. 11 shows an example of a time profile of a digital transmission signal, which is to be converted into bus signals CAN_H, CAN_L for a bus of the bus system of FIG. 1 in an arbitration phase, in which the transmitting/receiving device of the subscriber station is switched to a SIC operating mode.

FIG. 12 shows the time profile of the bus signals CAN_H, CAN_L during a change from a recessive bus state to a dominant_bus state and back to the recessive bus state, which bus signals are transmitted onto the bus in the arbitration phase due to the transmission signal of FIG. 11, wherein the transmitting/receiving device is switched to a SIC operating mode in the arbitration phase.

FIG. 13 shows a flowchart for a method carried out_by the subscriber station of FIG. 4, according to an example embodiment of the present invention.

FIG. 14 shows a simplified schematic block diagram of a subscriber station of the bus system according to a second exemplary embodiment of the present invention.

FIG. 15 shows a flowchart for a method that can be carried out by the subscriber station of FIG. 14, according to an example embodiment of the present invention.

FIG. 16 shows a state diagram for the method carried out_by the subscriber station of FIG. 15.

In the figures, identical or functionally identical elements are provided with the same reference signs unless stated otherwise.

### DETAILED DESCRIPTION OF EXAMPLE EMBODIMENTS

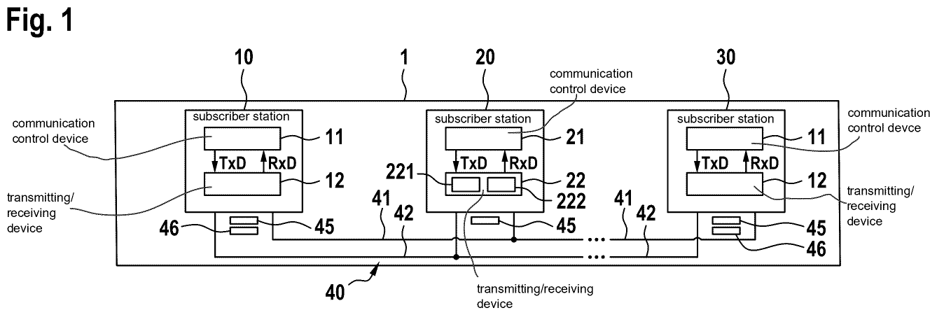

FIG. 1 shows an example of a bus system 1, which is in particular fundamentally configured for a CAN bus system, a CAN FD bus system, a CAN XL bus system, and/or modifications thereof, as described below. The bus system 1 may be used in any technical system; in particular, the bus system 1 may be used in a vehicle, in particular a motor vehicle, an aircraft, etc., or in a hospital, etc.

Although the bus system 1 is described below on the basis of CAN bus systems, the bus system 1 is not limited to CAN bus systems.

Alternatively, the bus system 1 may be any other serial bus system 1 that uses at least one operating mode switching in a message and/or uses differential signals.

The bus system 1 in FIG. 1 comprises a plurality of subscriber stations 10, 20, 30 that are each connected to a bus 40 or bus line by means of a first_bus wire 41 and a second bus wire 42. In a CAN bus system, the bus wires 41, 42 can also be called CANH and CANL for carrying signals CAN_H, CAN_L on the bus 40.

Messages 45, 46 in the form of signals can be transmitted between the individual subscriber stations 10, 20, 30 via the bus 40. The subscriber stations 10, 20, 30 are, for example, control devices or display devices of a motor vehicle.

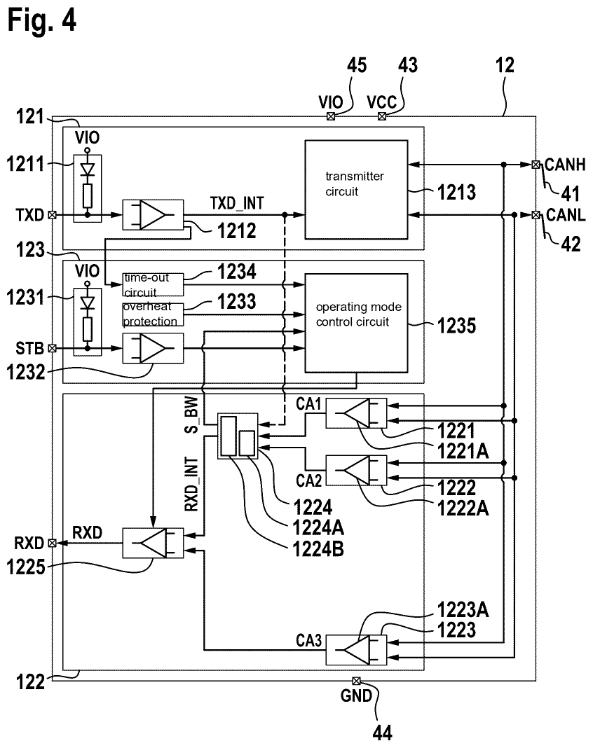

As shown in FIG. 1, the subscriber stations 10, 30 each have a communication control device 11 and a transmitting/receiving device 12. The transmitting/receiving device 12 comprises, among other things, a transmitter module and a receiver module, which are described in more detail in FIG. 4.

The subscriber station 20 comprises a communication control device 21 and a transmitting/receiving device 22. The transmitting/receiving device 22 comprises a transmitter module 221 and a receiver module 222.

The transmitting/receiving devices 12 of the subscriber stations 10, 30 and the transmitting/receiving device 22 of the subscriber station 20 are each connected directly to the bus 40, although this is not shown in FIG. 1.

The communication control devices 11, 21, are each used to control communication of the corresponding subscriber station 10, 20, 30 via the bus 40 with at least one other subscriber station of the subscriber stations 10, 20, 30 connected to the bus 40.

The communication control device 11 creates and reads first messages 45, which are, for example, CAN FD messages 45. The CAN FD messages 45 are structured on the basis of a CAN FD format, as standardized in ISO/DIS 11898-1:2023. The transmitting/receiving device 12 is used to transmit and receive the messages 45 from the bus 40. The transmitting/receiving device 12 receives a digital transmission signal TxD created by the communication control device 11 for one of the messages 45 and converts it into signals on the bus 40. The transmitting/receiving device 12 receives signals, transmitted on the bus 40, according to the message 45 or a second message 46 and generates a digital reception signal RxD therefrom. The transmitting/receiving device 12 transmits the reception signal RxD to the communication control device 11.

In addition, the communication control device 11 can be configured to create and read second messages 46, which are CAN XL messages 46. The CAN XL messages 46 are structured on the basis of a CAN XL format, as standardized in ISO/DIS 11898-1:2023. The digital transmission signal TxD is thus a pulse-width-modulated signal at least temporarily or in portions. The transmitting/receiving device 12 is configured accordingly.

The communication control device 21 may be designed like a conventional CAN controller according to ISO 11898-1:2015, i.e., like a CAN FD-tolerant Classical CAN controller or a CAN FD controller. The communication control device 21 creates and reads first messages 45, for example CAN FD messages. The transmitting/receiving device 22 is used to transmit and receive the messages 45 from the bus 40. The transmitter module 221 receives a digital transmission signal TxD created by the communication control device 21 and converts it into signals for a message 45 on the bus 40. The receiver module 222 receives signals, transmitted on the bus 40, according to one of the messages 45, 46 and generates a digital reception signal RxD therefrom. The transmitting/receiving device 22 may be designed like a conventional CAN FD transceiver or CAN SIC transceiver.

For transmitting the messages 45, 46 according to the CAN type CAN SIC or CAN XL, proven properties that are responsible for the robustness and user friendliness of CAN and CAN FD, in particular the frame structure with identifier and arbitration according to the conventional CSMA/CR method, are adopted. The CSMA/CR method requires so-called recessive states on the bus 40, which recessive states can be overwritten by other subscriber stations 10, 20, 30 with dominant levels or dominant states on the bus 40.

By means of the two subscriber stations 10, 30, it is possible to form and then transmit messages 45, 46 that have different CAN formats, in particular the CAN FD format or the CAN XL format. In addition, the two subscriber stations 10, 30 can be used to receive such messages 45, 46. This is described in more detail below for the messages 45, 46.

The communication control device 11 may, at least in part, be designed like a conventional CAN XL controller according to ISO/DIS 11898-1:2023. Thus, the communication control device 11 supports the transmission and/or reception of 7 different frame formats, namely, 4 Classical CAN frame formats, 2 CAN FD frame formats having 11-bit or 29-bit identifiers, and 1 CAN XL frame format. The communication control device 11 thus creates and reads a first message 45 or a second message 46, wherein the first and second messages 45, 46 differ in their data transmission standard, namely, CAN FD and CAN XL, for example.

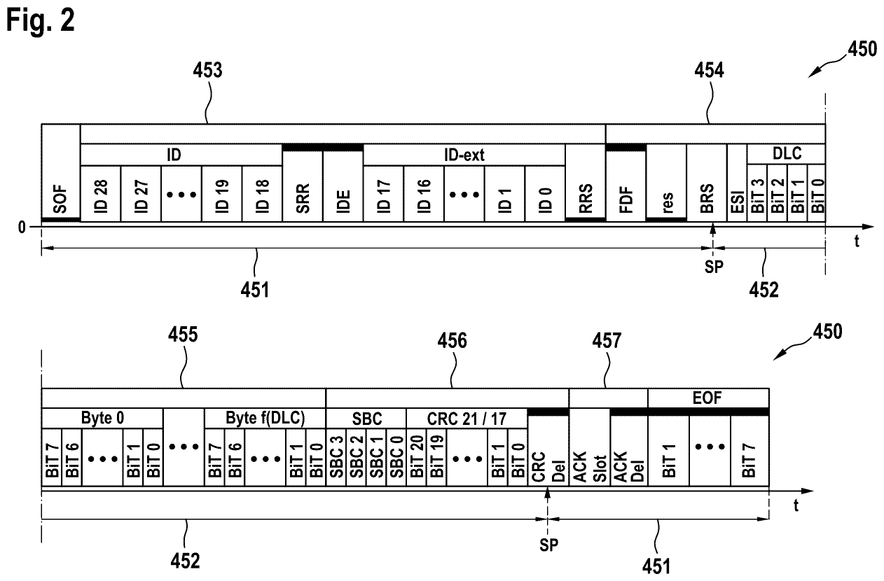

By way of example, FIG. 2 shows a CAN FD frame 450 with 29-bit identifier (ID), which the subscriber station 100 can use for communicating with the subscriber station 30 by means of messages 45 via the bus 40. In the case of the CAN FD messages 45, a number of 0 to 64 data bytes can be included, which are transmitted at a significantly faster data rate than in the case of a Classical CAN message.

FIG. 2 shows, by way of example, a frame 450, which can be created by one of the subscriber stations 10, 20, 30 over time t for a message 45 in the CAN FD FEFF format. The CAN FD frame 450, namely, encoded in a digital transmission signal TxD, can be provided by one of the communication control devices 11, 21 for the associated transmitting/receiving device 12, 22 for serial transmission onto the bus 40 to another subscriber station of the bus system 1, for example by the subscriber station 10 for the subscriber station 20 and/or the subscriber station 30.

The frame 450 is divided into two communication phases, which are called arbitration phase 451 (first communication phase) and data phase 452 (second communication phase). The frame 450 begins and ends in the arbitration phase 451. The frame 450 begins with an SOF bit and comprises an arbitration field 453, a control field 454, a data field 455, a checksum field 456 (CRC field), an acknowledgment field 457 (ACK) and an end-of-frame field EOF.

Bits in the arbitration phase 451 of the frame 450 may have a longer bit time than bits of the data phase 452, as illustrated in FIG. 2 by way of example. Switching from the bits with the bit time of the arbitration phase 451 to the bits with the bit time of the data phase 452 is carried out in the BRS bit, at the point denoted by SP in FIG. 2. SP stands for sample point.

Bits that are shown in FIG. 2 with a thick line at their lower line are transmitted in the frame 450 as dominant or ‘0’. Bits that are shown in FIG. 2 with a thick line at their upper line are transmitted in the frame 450 as recessive or ‘1’. Such bits, which are shown in FIG. 2 with a thick line, have a predetermined fixed or defined value in the frame 450.

The arbitration field 453 contains an identifier of the frame 450, which is divided into the two fields ID field and ID-ext field. The identifier has 29 bits. An SRR bit and an IDE bit are provided between the ID field and the ID-ext field. An RRS bit is arranged at the end of the arbitration field 453. FIG. 2 shows the FEFF format with the 29-Bit extended identifier. Alternatively, the subscriber station 10 or one of the subscriber stations 20, 30 may use a different CAN FD frame format, in particular a modified frame 450, which has an 11-bit identifier.

The control field 454 begins with an FDF bit, followed by a res bit. They are followed by the BRS bit and an ESI bit. The ESI bit is the first_bit in the frame 450 with the bit time of the data phase 452.

The control field 454 ends with a DLC field, in which the length of the following data field 455 is encoded. The res bit for the frame 450 must_be transmitted with a logical value 0, in other words, as (logical) 0, i.e., dominant.

If the DLC field of the control field 453 has the value 0, there is no data field 455. The data field 455 has a length corresponding to the value encoded in the DLC field. The value can be up to 64 bytes, as mentioned above.

In a field SBC, the checksum field 456 contains the number of stuff bits modulo 8, which have been inserted into the frame 450 according to the bit stuffing rule, namely, that following five identical bits, a bit inverse thereto is to be inserted in each case. In addition, the checksum field 456 contains a CRC checksum in a CRC field and ends with a subsequent CRC delimiter CRC Del.

Switching from the bits with the bit time of the data phase 452 to the bits with the bit time of the arbitration phase 451 is carried out in the CRC Del bit at the point denoted by SP in FIG. 2. SP stands for sample point.

The acknowledgment field 457 contains an ACK slot_bit, in which subscriber stations that are currently only receivers of the frame 450 but not transmitters of the frame can acknowledge or not acknowledge the correct reception of the frame 450 from the bus 40. The acknowledgment field 457 ends with an ACK Del bit, which is also called ACK delimiter.

A bit sequence which marks the end of the frame 450 is provided in the end-of-frame field EOF. The bit sequence of the end field (EOF) thus serves to mark the end of the frame 450. The end field (EOF), together with the ACK delimiter, ensures that a number of 8 recessive bits is transmitted at the end of the frame 450. This is a bit sequence that cannot occur within the frame 450. As a result, the end of the frame 450 can be reliably detected by the subscriber stations 10, 20, 30.

In the frame 450, the end field (EOF), which has 7 bits, is followed by an interframe space (IFS), which is not shown in FIG. 2. In CAN FD, this interframe space (IFS) is configured according to ISO 11898-1:2015. The interframe space (IFS) has at least 3 bits.

The mentioned fields and bits are otherwise known from ISO 11898-1:2015 and are therefore not described in more detail here.

In the arbitration phase 451 of CAN FD, with the aid of the identifier (ID) with, for example, bits ID28 to IDO in the arbitration field 453, the subscriber stations 100 or other CAN FD subscriber stations on the bus 40 negotiate, bit_by bit, which subscriber station 100 wants to transmit the message 45 with the highest priority and will therefore gain exclusive access to the bus 40 of the bus system 1 for the near future for transmitting in the subsequent data phase 452. In the arbitration phase 451, a physical layer is used as in CAN and CAN FD. The physical layer corresponds to the bit transmission layer or layer 1 of the conventional OSI (Open Systems Interconnection) model.

In the most general sense, the subscriber station 10 as the transmitter of a message 45 or 46 begins to transmit_bits of the data phase 452 onto the bus 40 only if the subscriber station 10 as the transmitter has won the arbitration and the subscriber station 10 as the transmitter thus has exclusive access to the bus 40 of the bus system 1 for transmission. The same applies to each of the subscriber stations 20, 30 that is connected to the bus 40 and wants to transmit a message 45 or 46 onto the bus 40.

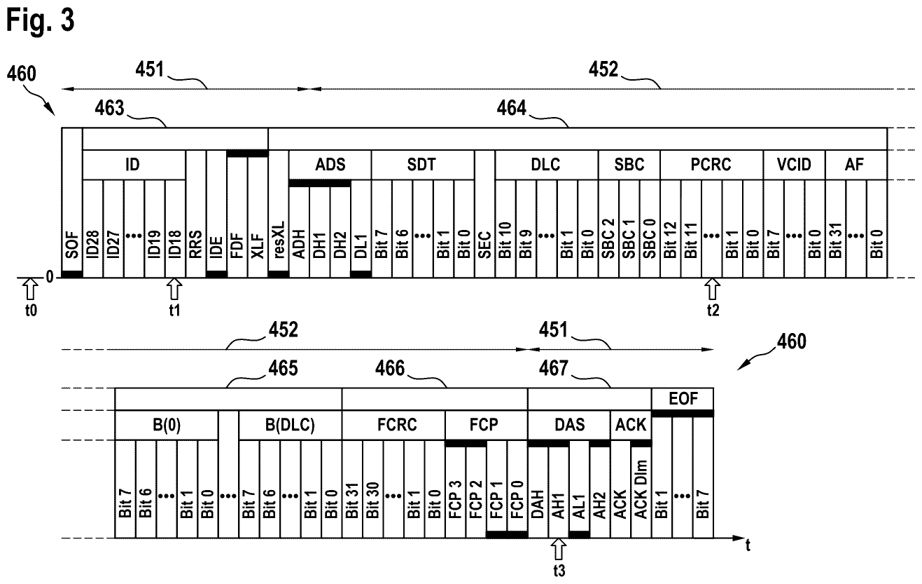

FIG. 3 shows, for the message 46, a CAN XL frame 460, namely, encoded in a digital transmission signal TxD, as provided by one of the subscriber stations 10, 30, more precisely its communication control device 11, for the associated transmitting/receiving device 12 for transmission onto the bus 40. In this case, the communication control device 11 creates the frame 460 in the present exemplary embodiment as compatible with CAN FD, as also illustrated in FIG. 3.

According to FIG. 3, the CAN XL frame 460 is also divided for CAN communication on the bus 40 into different communication phases 451, 452, namely, the arbitration phase 451 and the data phase 452. Following a start_bit (SOF), the frame 460 has an arbitration field 463, a control field 464 with an ADS field for switching between the communication phases 451, 452, a data field 465, a checksum field 466, and a frame termination field 467. This is followed by the end-of-frame field EOF, as in a frame 450 according to FIG. 2. The CAN XL format is defined in ISO/DIS 11898-2:2023.

In the arbitration phase 451, arbitration is also carried out for the frame 460 of FIG. 3 with the aid of the identifier (ID), as described above with reference to FIG. 2 for the various bus configurations. In the arbitration phase 451, an arbitration bit rate of less than or equal to 1 Mbit/s is used in the present exemplary embodiment.

According to FIG. 3, in the data phase 452, in addition to a portion of the control field 464 of the frame 460, the payload data of the CAN XL frame 460 or of the message 46 from the data field 465 as well as the checksum field 466 are transmitted. In the data phase 452, in the present exemplary embodiment, a data bit rate that can have values of in particular up to 20 Mbit/s is used.

In the case of CAN XL according to FIG. 3, the data phase 452 is followed by the DAS field, which is used for switching from the data phase 452 back to the arbitration phase 451. Whether switching is used or not is settable in the CAN XL protocol on layer 2 of the conventional OSI model (Open System Interconnection Model). In the transmitting/receiving device 12, switching is activated so that the operating mode of the transmitting/receiving device 12 for the data phase 452 is changeable in ongoing operation.

As shown in FIG. 3, in the arbitration phase 451 as the first communication phase, the subscriber station 10 and the subscriber station 30 use the format from CAN FD according to ISO/DIS 11898-1:2023, as shown in FIG. 2 and described below, in part, in particular up to the FDF bit (inclusive). In contrast, the subscriber station 10 and the subscriber station 30 use a CAN XL format, as described above, from the FDF bit in the first communication phase 451 as well as in the data phase 452 as the second communication phase. In the CAN XL data phase 452, symmetrical ‘1’ and ‘0’ levels can be used for the transmission on the bus 40, rather than recessive and dominant levels as with CAN FD, if the corresponding transmitting/receiving devices for CAN XL are used.

In general, two different stuffing rules are used when generating the frame 460. The dynamic bit stuffing rule of CAN FD applies up to before the FDF bit in the arbitration field 453 or for a frame 450 of FIG. 2 so that, after 5 identical bits in succession, a stuff bit inverse thereto is to be inserted. In the data phase 452 up to before the FCP field in FIG. 3, a fixed stuffing rule applies so that a fixed stuff bit that is inverse to the preceding bit is to be inserted after a fixed number of bits.

In the present exemplary embodiment, the res bit, which is from CAN FD and denoted by XLF bit in the frame 460, is used for switching from the CAN FD format to the CAN XL format. For this reason, the frame formats of CAN FD and CAN XL are identical up to the res bit or XLF bit. Only at this bit does a receiver detect the format in which the frame 460 is transmitted. If the bit is transmitted as 1, i.e., recessive, it is the XLF bit and thus identifies the frame 460 as a CAN XL frame. For a CAN FD frame of FIG. 2, the communication control device 11, 31 sets the bit as 0, i.e., as a dominant res bit.

In the frame 460, the XLF bit is followed by a resXL bit, which is a dominant_bit for future use. The resXL for the frame 460 must_be transmitted as 0, i.e., dominant.

In the frame 460, the resXL bit is followed by a sequence ADS (arbitration data switch), in which a predetermined bit sequence is encoded. This bit sequence allows for simple and reliable switching from the bit rate of the arbitration phase 451 (arbitration bit rate) to the bit rate of the data phase 452 (data bit rate). Optionally, the operating mode of the transmitting/receiving device 12 is switched within the ADH bit from the operating mode B_451 (SIC) of the arbitration phase 451 to one of two operating modes B_452 TX, B_452 RX of the data phase 452. The two operating modes of the data phase 452 are an operating mode B_452 TX (FAST_TX) for a transmitting node that is allowed to transmit its signal onto the bus 40 in the data phase 452 and an operating mode B_452 RX (FAST RX) for a receiving node that is only the receiver of the signal from the bus 40. In order to achieve data bit rates of up to 20 Mbit/s, the physical layer, i.e., the operating mode of the transmitting/receiving device 12, is switched within the ADH bit from SIC to FAST_TX or FAST RX. Switching of the physical layer is necessary if data bit rates of over 8 Mbit/s are required or if a complex CAN bus topology is used, which is the case with long branch lines, for example.

Subsequent fields up to the beginning of the data field 465 are not described in more detail here. The data field 465 can have up to 2048 bytes. The length of the data field 465 is encoded in bits 0 to 10 of the DLC field.

In the frame 460, the data field 465 is followed by the checksum field 466 with a frame checksum FCRC and an FCP field. Here, FCP=frame check pattern. The FCP field consists of 4 bits with, in particular, the bit sequence 1100. A receiving node uses the FCP field to check whether the receiving node is bit-synchronous with the transmission data stream. In addition, a receiving node synchronizes to the falling edge in the FCP field.

The FCP field is followed by the frame termination field 467. The frame termination field 467 consists of two fields, namely, the DAS field and the acknowledgment field or ACK field with the at least one ACK bit and the ACK Dlm bit.

The DAS field contains the DAS (data arbitration switch) sequence, in which a predetermined bit sequence is encoded. The DAH, AH1, AL1 bit sequence allows for simple and reliable switching from the data bit rate of the data phase 452 to the arbitration bit rate of the arbitration phase 451. In addition, during the DAS field, more precisely in the DAH bit, the operating mode of the transmitting/receiving device 12 is optionally switched from the operating mode B_452 TX or B_452 RX (FAST) to the operating mode B_451 (SIC). If the physical layer was previously switched, the physical layer is switched within the DAH bit. The AH1 bit is followed by the AL1 bit (logical 0) and the AH2 bit (logical 1). The two bits DAH and AH1 ensure that there is enough time for the operating mode switching of the transmitting/receiving device 11, and that all subscriber stations 10, 30 see a recessive level of significantly more than one arbitration bit time before the edge at the beginning of the AL1 bit (logical 0). This ensures reliable synchronization for the subscriber stations of the bus system.

In the frame termination field 467, the sequence of the DAS field is followed by the acknowledgment field (ACK). In the acknowledgment field, bits are provided for acknowledging or not acknowledging correct reception of the frame 460.

In the frame 460, the frame termination field 467 is followed by the end-of-frame field (EOF), as in the case of CAN FD according to FIG. 2.

For subscriber stations whose error signaling is not activated and which transmit a CAN XL frame, the end-of-frame field (EOF) has a length which is different depending on whether a dominant bit or a recessive bit has been seen in the ACK bit. If the transmitting subscriber station has received the ACK bit as dominant, the end-of-frame field (EOF) has a number of 7 recessive bits. Otherwise, the end-of-frame field (EOF) is only 5 recessive bits long.

In the frame 460, the end-of-frame field (EOF) is followed by an interframe space (IFS), as explained above with reference to the frame 450 of FIG. 2.

The following applies to CAN XL.
In contrast to CAN FD, the identifier ID of the frame 460 is called priority ID in CAN XL.
In contrast to CAN FD, CAN XL can transmit the RRS bit as (logical) 0 or as (logical) 1. In CAN FD, the RRS bit is always transmitted as logical 0.

Also shown in FIG. 3 are examples of possible times t0, t1, t2, t3 at which subscriber station 10 can be switched on during the transmission of a frame 460 by the subscriber station 30. No matter at which of the times t0, t1, t2, t3 or when the subscriber station 10 is switched on, the subscriber station 10 (node) will have been at least once in the data phase 452 within N edges F1, F2 to be counted in a signal in FIG. 8 generated by its transmitting/receiving device 12. Accordingly, the transmitting/receiving device 12 is constructed and configured as shown in FIG. 4 and described below.

FIG. 4 shows the basic structure of the transmitting/receiving device 12, which is usable for any of the subscriber stations 10, 30. The transmitting/receiving device 12 has a transmitter module 121, a receiver module 122, an operating mode control module 123, a terminal TXD for the transmission signal TxD, a terminal RXD for the reception signal RxD, a terminal STB, a terminal CANH for the signal CAN_H for the first_bus wire 41, a terminal CANL for the signal CAN_L for the second bus wire 42, a terminal 43 or VCC for a voltage supply VCC of the transmitting/receiving device 12, a terminal 44 for ground (GND), and a terminal 45 for VIO (terminal for the supply voltage of the I/O pins).

As shown in FIG. 4, the transmitter module 121 has a series circuit 1211, which comprises a diode and resistor and is connected to the terminal 45 (VIO). In addition, the transmitter module 121 has a buffer memory 1212 and a transmitter circuit 1213. As shown in FIG. 4, the transmitter module 121 is also connected to the terminal TXD and the terminals CANH, CANL. The terminals CANH, CANL are bi-directional terminals for transmitting and receiving signals from the bus wires 41, 42 of the bus 40. The transmitter module 121 is also connected to the operating mode control module 123. Optionally, the transmitter module 121 is connected to the receiver module 122. As a result, an internal transmission signal TxD INT output_by the buffer memory 1212 may optionally be forwarded not only to the transmitter circuit 1213 but also to the receiver module 122.

The receiver module 122 has a first receiver circuit 1221, a second receiver circuit 1222, a third receiver circuit 1223, a logic circuit 1224, and a driver circuit 1225. As shown in FIG. 4, the receiver module 122 is also connected to the terminal RXD and the terminals CANH, CANL. More precisely, each of the receiver circuits 1221, 1222, 1223 of the receiver module 122 is connected to the terminals CANH, CANL. The receiver module 122 is also optionally connected to the transmitter module 121, as already mentioned. The receiver module 122 is also connected to the operating mode control module 123. As a result, an output signal of the logic circuit 1224, in particular a switching signal S_BW, can be forwarded to the operating mode control module 123. Additionally, or alternatively, an internal reception signal, RxD_INT, may be forwarded not only to the driver circuit 1225 but also to the operating mode control module 123.

According to FIG. 4, the first receiver circuit 1221 has a first comparator 1221A and a bus bias voltage source (not shown). The receiver circuit 1221 outputs a signal CA1. The second receiver circuit 1222 has a second comparator 1222A. The receiver circuit 1222 outputs a signal CA2. The third receiver circuit 1223 has a third comparator 1223A and a wake-up filter (not shown), which checks whether the subscriber station is to be woken up again after entering sleep mode. The receiver circuit 1223 outputs a signal CA3. The logic circuit 1224 has a counting block 1224A and an evaluation block 1224B, and is explained in more detail below, with reference to FIG. 13 as well. The logic circuit 1224 outputs the internal reception signal RxD_INT and a switching signal S_BW. The driver circuit 1225 has a driver for driving a reception signal RxD to the terminal RXD. The driver circuit 1225 also has a multiplexer, which is not shown in FIG. 4. For example, the comparators 1221A, 1222A, 122B and the driver are each low-voltage operational amplifiers.

The operating mode control module 123 has a series circuit 1231, which comprises a diode and resistor and is connected to the terminal 45 (VIO). In addition, the operating mode control module 123 has a buffer memory 1232, an overheat protection circuit 1233, a time-out detection circuit 1234 (time-out circuit), and an operating mode control circuit 1235. As shown in FIG. 4, the operating mode control module 123 is also connected to the terminal STB. However, the operating mode control module 123 is not connected to the terminals CANH, CANL. The at least one output signal of the logic circuit 1224 is input into the operating mode control circuit 1235, as described above.

The terminals TXD, RXD, STB are connectable to corresponding terminals of the communication control device 11 of FIG. 1. The terminal STB is usable for a signal that the communication control device 11 transmits to the transmitting/receiving device 12 in order to switch the transmitting/receiving device 12 to the operating modes B_452 TX (FAST_TX) or B_452 RX (FAST RX) or B_451 (SLOW or SIC) for the arbitration phase 451 and to control the data phase 452 with the aid of the operating mode control module 123. This switching of the transmitting/receiving device 12 is described above.

The voltage supply VCC of the transmitting/receiving device 12 usually supplies a voltage CAN Supply of 5 V at the terminal 43. However, the voltage supply VCC can supply a different voltage with a different value as needed. Additionally, or alternatively, the terminal 43 may be connected to a current source as a power supply device. The3lecond31t3Inns of the terminals 43, 44, 45 to the modules 121, 122, 123 and to their aforementioned components, such as circuits 1213, etc., are not shown in FIG. 4 for reasons of clarity.

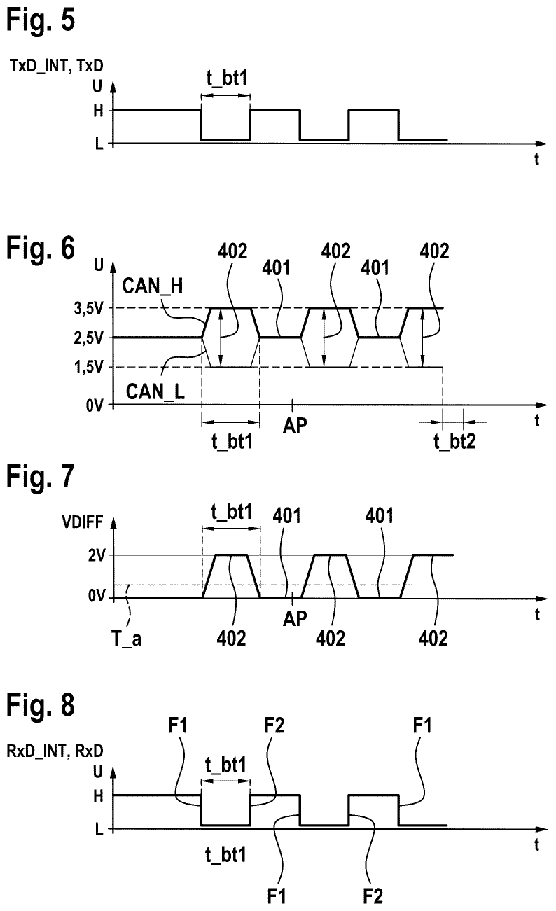

During operation of the bus system 1, the transmitter module 121 of FIG. 4 can serially convert a transmission signal TxD of the communication control device 11, for example the transmission signal TxD of FIG. 5, into corresponding signals CAN_H, CAN_L for CAN or CAN FD or CAN XL for the bus wires 41, 42 and can transmit these signals onto the bus 40 at the terminals CANH for CAN_H and CANL for CAN_L.

The communication control device 11 transmits the transmission signal TxD of FIG. 5 over time t (serially) via the terminal TXD to the transmitter module 121, as shown in FIG. 4. As shown by way of example in FIG. 5, the transmission signal TxD has the voltage states HI (high) and L (low) with a corresponding voltage U. The transmission signal TxD of FIG. 5 is temporarily stored in the buffer memory 1212 of FIG. 4 and is output as an internal transmission signal TxD INT. The profile of the transmission signal TxD of FIG. 5 over time t is identical to the profile of the internal transmission signal TxD INT even if the internal transmission signal TxD INT is somewhat delayed in time in comparison to the transmission signal TxD due to the propagation time to the output of the buffer memory 1212. The delay is not shown in the figures for the sake of clarity.

According to the example of FIG. 6, the signals CAN_H and CAN_L for a frame 450 of FIG. 2 or frame 460 of FIG. 3 (without operating mode switching of the transmitting/receiving device) in the arbitration phase 451 have the dominant and recessive bus levels 401, 402, as from CAN. A difference signal VDIFF=CAN_H−CAN_L, which is shown in FIG. 7 for the arbitration phase 451, forms on the bus 40. The individual bits of the signal VDIFF with the bit time t_bt1 can be detected in the arbitration phase 451 and the data phase 452 by means of a reception threshold T_a of, for example, 0.7 V, in particular by means of the receiver circuit 1221 of FIG. 4. In the data phase 452 of a frame 450, the bits of the signals CAN_H and CAN_L can be transmitted faster, i.e., with a shorter bit time t_bt2, than in the arbitration phase 451, as mentioned above. The signals CAN_H and CAN_L in CAN FD for the frame 450 or in CAN XL for the frame 460 thus differ in the data phase 452 from the conventional signals CAN_H and CAN_L, at least in their faster bit rate.

The sequence of the states H, L of the transmission signal TxD of FIG. 5 and the resulting states 401, 402 for the signals CAN_H, CAN_L in FIG. 6 as well as the resulting profile of the voltage VDIFF of FIG. 7 are used only to illustrate the function of the subscriber station 100. The sequence of the data states for the bus states 401, 402 is selectable as needed.

According to FIG. 4, the receiver module 122 forms the digital comparator signals CA1, CA2, CA3, and subsequently the digital internal reception signal RxD_INT, which is shown in FIG. 4 and FIG. 8, from signals CAN_H and CAN_L (FIG. 6) received from the bus 40 or from the differential voltage VDIFF (FIG. 7). For generating the digital signals CA1, CA2, CA3 and thus the digital reception signal RxD of FIG. 8, the receiver module 122 in particular uses at least one of its receiver circuit(s) 1221, 1222 to evaluate the signal(s) from the bus 40 by means of at least one of the reception thresholds T_a, etc., as described in more detail below with reference to FIG. 10.

The driver circuit 1225 of FIG. 4 forms/generates the reception signal RxD from the internal reception signal RxD_INT. The profile of the reception signal RxD of FIG. 8 over time t is identical to the profile of the internal reception signal RxD_INT even if the reception signal RxD is somewhat delayed in comparison to the internal reception signal RxD_INT due to the propagation time to the output of the driver circuit 1225. The delay is not shown in the figures for the sake of clarity.

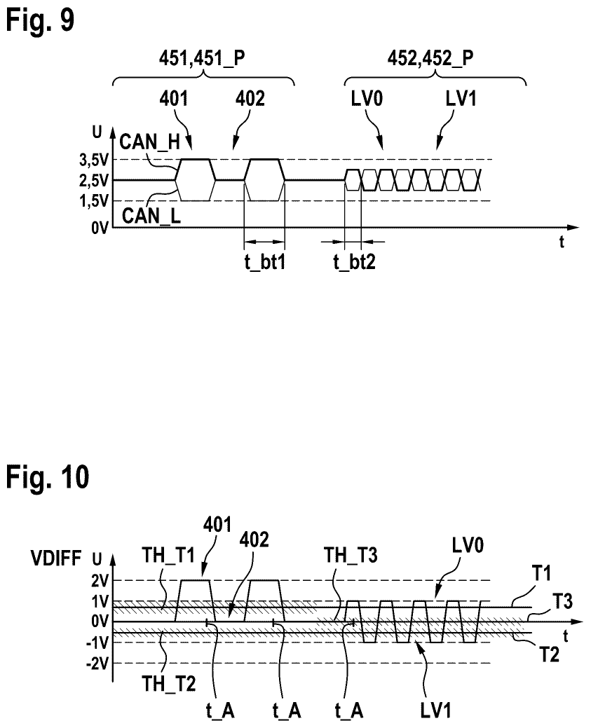

If one of the CAN XL-capable subscriber stations 10, 30 uses the operating mode switching of the transmitting/receiving device 12, which can be switched on/off via the configuration according to ISO/DIS11898-1:2023, the signals of FIG. 9 and FIG. 10, instead of the signals of FIG. 6 and FIG. 7, apply to a message 46 based on a frame 460 of FIG. 3.

As shown in FIG. 9, in the arbitration phase 451, the transmitting/receiving devices 12 of FIG. 4 uses a first physical layer 451_P to transmit a transmission signal TxD (FIG. 5) over time t as signals CAN_H, CAN_L onto the bus 40. The same applies to the transmitting/receiving device 22 of FIG. 1. In contrast, in the data phase 452, for data bit rates of up to 20 Mbit/s, the transmitting/receiving device 12 can use a second physical layer 452_P, which is different from the first physical layer 451_P, to transmit the transmission signal TxD (FIG. 5) as signals CAN_H, CAN_L onto the bus 40, as described above. There are two operating modes for the physical layer 452_P, namely, FAST_TX and FAST RX, as described above.

On the left side, FIG. 9 shows that the subscriber stations 10, 20, 30 in the arbitration phase 451 each transmit signals CAN_H, CAN_L, which have a first_bit duration t_bt1, over time t onto the bus 40. The signals CAN_H, CAN_L are serial signals and alternately have at least one dominant state 401, in which, at a supply voltage VCC=5 V, VCAN_H=3.5 V and VCAN_L=1.5 V, or at least one recessive state 402, in which VCAN_H=VCAN_L=2.5. A dominant state 401 (dom) is driven during NRZ encoding of the34econd34tssion signal TxD in the phase 451 if TXD=0 or LW (low) (FIG. 5). A recessive state 402 (rec) is generated or occurs during NRZ encoding of the transmission signal TxD in the phase 451 if TXD=1 or HI (high) (FIG. 5). After the arbitration in the arbitration phase 451, one of the subscriber stations 10, 20, 30 is the decided winner.

If the communication control device 11 of the particular subscriber station 10, 30 starts the signaling in the first switching field ADS of FIG. 3 for switching from the first to the second communication phase 451, 452, the associated transmitting/receiving device 12 switches its physical layer 451_P at the end of the arbitration phase 451 from a first operating mode (SLOW), which, with a SIC transmitting/receiving device, may alternatively be designed as a SIC operating mode, to the physical layer 452_P of the data phase 452. For this purpose, the operating modes of the data phase 452 are switched on, as described above with reference to FIG. 3.

As shown on the right side in FIG. 9, in the data phase 452 or in the second operating mode (FAST_TX), the transmitter module 121 then generates the states LV1 or LV1 by means of the physical layer 452_P for the signals CAN_H, CAN_L on the bus 40 one after the other and thus serially depending on a transmission signal TxD (FIG. 5). In the case of pulse width modulation (PWM encoding) of the transmission signal TxD, the state LV0 (VCAN_H=3.0 V, VCAN_L=2.0 V) is driven for a first PWM symbol in the transmission signal TxD. The state LV1 (VCAN_H=2.0 V and VCAN_L=3.0 V) in the case of the pulse width modulation (PWM encoding) of the transmission signal TxD is driven for a second PWM symbol, which is different from the first PWM symbol, in the transmission signal TxD.

The frequency of the signals CAN_H, CAN_L can be increased in the data phase 452. For this purpose, in the example in FIG. 9, the bit time or bit duration t_bt2 in the data phase 452 is shorter or less than the bit time or bit duration t_bt1 in the arbitration phase 451. In the example of FIG. 9, the net data transmission rate in the data phase 452 is thus increased in comparison to the arbitration phase 451.

In contrast, the transmitting/receiving device 12 of the subscriber station 30, for example, switches its physical layer 451_P at the end of the arbitration phase 451 from the first operating mode (SIC) to the physical layer 452_P of the data phase 452 for a third operating mode (FAST RX) of the transmitting/receiving device 12 since the subscriber station 30 in the present example is only a receiver, i.e., not a transmitter, of the frame 450 in the data phase 452.

If the transmitting/receiving device 12, in particular by means of the signaling in the second switching field DAS of FIG. 3, detects that switching from the data phase 452 back to the arbitration phase 451 is to be carried out, the transmitting/receiving device 12 is switched from transmitting (operating mode FAST_TX) (and) or receiving (operating mode FAST RX) signals by means of the physical layer 452_P to transmitting and/or receiving signals by means of the physical layer 451_P. All transmitting/receiving devices 12, 22 thus switch their operating mode to the first operating mode (SIC) after the end of the data phase 452. All transmitting/receiving devices 12 can thus not only switch between the bit durations t_bt1, t_bt2 but also switch their physical layer, as described above.

According to FIG. 10, in the ideal case, a difference signal VDIFF=CAN_H-CAN_L with values of VDIFF=2 V for dominant states 401 (dom) and VDIFF=0 V for recessive states 402 (rec) is formed in the arbitration phase 451 over time t on the bus 40. The profile of VDIFF in the phase 451 is shown on the left side in FIG. 11. In contrast, a differential signal VDIFF=CAN_H-CAN_L according to the states LV0, LV1 of FIG. 9 forms in the data phase 452 over time t on the bus 40, as shown on the right side in FIG. 10. The state LV0 has a value VDIFF=1 V. The state LV1 has a value VDIFF=−1 V.

The receiver module 122 can distinguish the states 401, 402, in each case with one of the reception thresholds T1, T2, T3, which are in the ranges TH T1, TH T2, TH T3. For evaluating the signals from the bus 40, the receiver module 122, in particular its receiver circuit 1221, in the arbitration phase 451 uses the reception threshold T1 of, for example, 0.7 V, which may be identical to the reception threshold T_a in FIG. 7, to generate the reception signal RxD. Optionally, the receiver module 122, in particular the receiver circuit 1222, also uses the reception threshold T2 of, for example−0.35 V. In contrast, the receiver module 122, in particular its receiver circuit 1221, uses the reception threshold T3 in the data phase 452 to evaluate the signals from the bus 40 in order to generate the reception signal RxD. When switching between the first to third operating modes (SLOW or SIC, FAST_TX, FAST RX) described above with reference to FIG. 9, the receiver module 122 switches the reception thresholds T1, T3 in each case, as shown in FIG. 10.

The reception thresholds T1, T2 are used to detect whether the bus 40 is free, if the subscriber station 12, in particular its transmitting/receiving device 12, is newly added to the communication on the bus 40 and attempts to integrate itself into the communication on the bus 40.

When receiving the corresponding signals from the bus 40, each transmitting/receiving device 12 generates the associated reception signal RxD, as shown in FIG. 8 and as described in more detail above. The reception signal RxD ideally does not have a time offset to the transmission signal TxD.

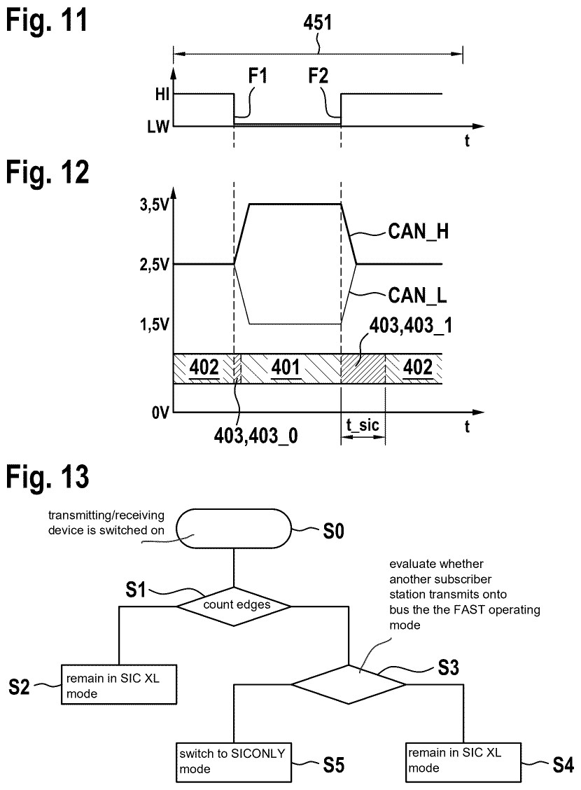

As shown in more detail in FIG. 11 and FIG. 12, for the transmission signal TxD of FIG. 11, the transmitter module 121 in the first operating mode (SIC) generates the signals CAN_H, CAN_L according to FIG. 12 for the bus wires 41, 42 such that a state 403 (sic) is additionally present. The state 403 (sic) can be of different lengths, as shown with the state 403 0 (sic) in the transition from the state 402 (rec) into the state 401 (dom), which takes place due to the falling edge F1 of the transmission signal TxD of FIG. 11, and with the state 403_1 (sic) in the transition from the state 401 (dom) into the state 402 (rec), which takes place due to the rising edge F2 of the transmission signal TxD of FIG. 11. The state 403 0 (sic) is shorter in terms of time than the state 403_1 (sic). In order to generate signals according to FIG. 12, the transmitter module 121 is switched to the first operating mode (SIC).

Passing through the short sic state 403 0 is not required in ISO/FDIS 11898-2:2023, and the state is dependent on the type of implementation. The duration of the “long” state 403_1 (sic) for the first operating mode (SIC) is specified as t sic<530 ns, starting with the rising edge F2 of the transmission signal TxD of FIG. 11.

If the transmitting/receiving device 12 of FIG. 4 is switched on, the transmitting/receiving device 12 always starts in the mode SIC XL. The transmitter module 121 is thus set to generate signals according to FIG. 12 on the bus 40 in the arbitration phase 451 (first operating mode SIC) and to receive or generate signals according to the right side of FIG. 9 in the data phase 452 (second operating mode XL). In addition, the second comparator 1222A of the second receiver circuit 1222 is used to detect whether another subscriber station on the CAN bus 40 is transmitting onto the bus 40 in the operating mode XL, which may also be called FAST operating mode. This function is in particular relevant after switching on the subscriber stations 10, 30 or after detecting a reception error. From the signals CA1, CA2, the logic circuit 1224 forms the internal reception signal RxD_INT, in particular by means of a logical AND operation.

The transmitting/receiving device 12 of FIG. 4, for example the logic circuit 1224, in particular its counting block 1224A, counts edges F1, F2, in particular falling edges F1 or rising edges F2 or falling and rising edges F1, F2, in the reception signal RxD_INT (FIG. 8). A falling edge F1 occurs between the states HI (high), LW (low) of the reception signal RxD_INT in FIG. 8. A rising edge F2 occurs between the states LW (low), HI (high) of the reception signal RxD_INT in FIG. 8. In addition, for example, the logic circuit 1224 of FIG. 4, in particular its evaluation block 1224A, evaluates whether the number of counted edges has exceeded a predetermined number N or not. N is a natural number. N may thus have a value equal to or greater than 1. N is an integer design parameter that is selectable as needed.

In the present exemplary embodiment, N is, for example, selected for the subscriber station 10 such that the communication control device 11 of FIG. 1 transmits or receives at least a portion of the data phase 452 of a frame 460 during the N edges.

If the transmitting/receiving device 12 of FIG. 4, for example the logic circuit 1224, in particular its counting block 1224A, has counted N edges and the second comparator 1222A of the second receiver circuit 1222 meanwhile has not detected the reception threshold T2 (FIG. 10) being fallen below, the logic circuit 1224, for example, in particular its evaluation block 1224A, evaluates that the transmitting/receiving device 12 of FIG. 4 is in a SIC bus system 1.

As a result, the logic circuit 1224, for example, in particular its evaluation block 1224A, outputs the reception signal RxD_INT to the driver circuit 1225 and outputs the additional switching signal S_BW and/or the reception signal RxD_INT to the operating mode control module 123 so that the transmitting/receiving device 12 of FIG. 4 is switched to the SICONLY mode. In the SICONLY mode, the transmitting/receiving device 12 of FIG. 4 behaves like a SIC transmitting/receiving device that uses the CAN SIC type and therefore transmits or receives signals according to FIG. 12 in the arbitration phase 451 and the data phase 452 (first operating mode SIC). Operating mode switching between the phases 451, 452 is switched off. In the data phase 452, bit rates of up to 8 Mbit/sec are possible here.

For example, in a CAN bus system 1, the predetermined number N could be selected in the range of N=15 to N=20 if only falling edges F1 are counted. N is thus selected such that at least two of the edges F1 of a frame 450, 460 on the bus 40 are reliably counted in the data phase 452. This is because, prior to the data phase 452, a CAN XL frame 460 of FIG. 3 has a maximum of 20 bits with a maximum of about 10 falling edges F1. In addition, after the data phase 452, the CAN XL frame 460 has a maximum of 13 bits with a maximum of 2 falling edges.

As shown in FIG. 3, the subscriber station 10 will thus have been at least once in the data phase 452 within the N edges to be counted in the internal reception signal RxD_INT, no matter at which of the times to to t3 the subscriber station 10 or the transmitting/receiving device 12 is switched on.

In this way, it is reliably detectable whether the transmitting/receiving device 12 is possibly switched to the operating mode FAST (FAST-RX or FAST-TX) in the data phase 452.

FIG. 13 shows a flowchart for a method carried out, for example, by the transmitting/receiving device 12, in particular by the logic circuit 1224, of FIG. 4 for the functions described above. The method starts with step S0.

At the beginning, the initial state/step S0, the transmitting/receiving device 12 of FIG. 4 is switched on. The transmitting/receiving device 12 starts in the SIC XL mode. Thus, in step S0, the receiver module 122 is initially set to receive signals according to FIG. 12 on the bus 40 in the arbitration phase 451 (first operating mode) and to receive signals according to the right side of FIG. 9 in the data phase 452 (second operating mode XL). The receiver circuit 1222 is, in particular only, switched on during the arbitration phase 451. The logic circuit 1224 forms the internal reception signal RxD_INT from the signals CA1, CA2 of the circuits 1221, 1222, in particular by means of a logical AND operation. Subsequently, the method proceeds to step S1.

In step S1, the transmitting/receiving device 12 of FIG. 4, for example the logic circuit 1224, in particular its counting block 1224A, counts the edges in the internal reception signal RxD_INT up to the predetermined number N. For example, the transmitting/receiving device 12 is set to count 15 falling edges. Once 15 falling edges are counted, the count value of the counting block 1224A is reset to zero. This will restart counting. If 15 edges are not counted, the method proceeds to step S2. If 15 edges are counted, the method proceeds to step S3.

In step S2, the transmitting/receiving device 12 of FIG. 4 remains in the SIC XL mode. Additionally, the transmitter module 121 can now also be set to generate signals according to FIG. 12 on the bus 40 in the arbitration phase 451 and to generate signals according to the right side of FIG. 9 in the data phase 452. In the SIC XL mode, only frames 460 can be transmitted or received. Optionally, the method returns to step S1.

In step S3, the receiver module 122, for example the logic circuit 1224, in particular its evaluation block 1224B, evaluates whether another subscriber station 10, 20, 30 on the CAN bus 40 transmits onto the bus 40 in the FAST operating mode during the time period in which the N edges were detected. That is to say, it is evaluated, by means of the logic circuit 1224 on the basis of the signal CA2 of the 41econdd comparator 1222A, whether or not the second reception threshold T2 (FIG. 10) is fallen below during said time period. If the reception threshold T2 (FIG. 10) is exceeded, the method proceeds to step S4. If the reception threshold T2 (FIG. 10) is not exceeded, the method proceeds to step S5.

In step S4, the transmitting/receiving device 12 of FIG. 4 remains in the SIC XL mode. In addition, the transmitting/receiving device 12 of FIG. 4 sets a signal, which indicates that the reception threshold T2 (FIG. 10) has been falling below, to the value LW (low). The signal may be a signal OOB-detected, which the logic circuit 1224 generates from the comparator signal CA2. The signal OOB-detected may be identical to the signal S_BW. Furthermore, the setting of the transmitter module 121 may be carried out as described above with respect to step S2.

In step S5, the transmitting/receiving device 12 of FIG. 4 switches from the SIC XL mode to the SICONLY mode and stops counting by means of the counting block 1224A. Accordingly, the transmitting/receiving device 12 of FIG. 4 has detected that the transmitting/receiving device 12 of FIG. 4 is in a SIC bus system 1. The transmitting/receiving device 12 of FIG. 4 therefore may no longer switch to the operating mode XL, which may also be called FAST. In the arbitration phase 451 and the data phase 452, signals according to FIG. 12 are thus transmitted or received by means of the device 12 (first operating mode SIC). No switching of the operating mode between the phases 451, 452 and thus also between the phases 452, 451 is carried out. In the data phase 452, bit rates of up to 8 Mbit/sec are possible here. In addition, the receiver circuit 1222 is switched off not only in the data phase 452 but also in the arbitration phase 451 so that the power input into the transmitting/receiving device 12 is lower and the device 12 consumes less electrical energy than in the operating mode SIC XL. In the SICONLY mode, frames with the format of frame 450 or frame 460 may be transmitted or received as specified by the communication control device 11 during operation of the bus system 1. In the frames 460, the fields DAH and ADH indicate that no switching between the phases 451, 452, and thus no switching between the phases 452, 451, is carried out.

The method is terminated when the transmitting/receiving device 12 of FIG. 4 is switched off.

In these ways, it is reliably detectable, in each case, in which type of bus system 1 the transmitting/receiving device 12 is used, for example in a CAN bus system 1 with switching of the operating mode for the data phase 452 or in a CAN bus system 1 without switching of the operating mode for the data phase 452.

After being switched on (again), the transmitting/receiving device 12 can itself detect whether it possibly has been/is being switched to the operating mode FAST (FAST-RX or FAST-TX).

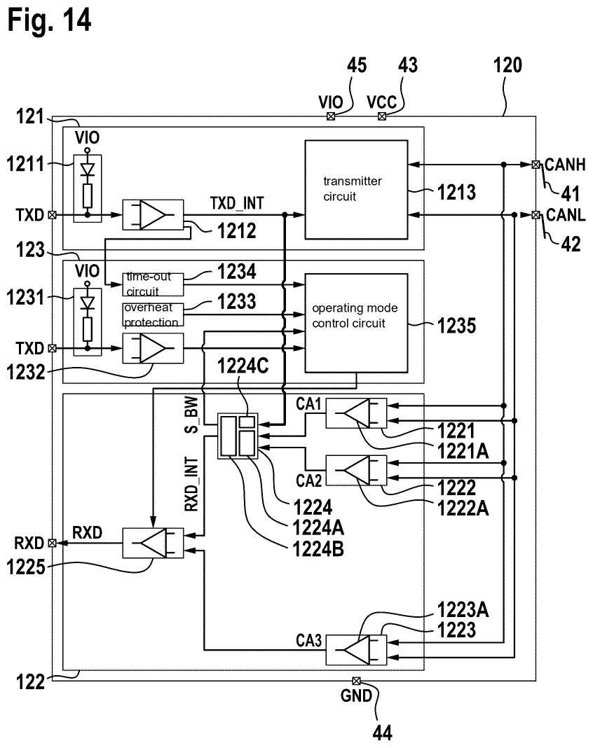

FIG. 14 shows a transmitting/receiving device 120 according to a second exemplary embodiment.

In contrast to the transmitting/receiving device 12 according to the above-described exemplary embodiment, the transmitting/receiving device 120 according to the second exemplary embodiment additionally comprises a transmission signal evaluation block 1224C for evaluating the transmission signal TxD INT and thus the transmission signal TxD.

For example, the transmission signal evaluation block 1224C sets the switching signal S_BW accordingly when the evaluation block 122C has detected a predetermined PWM symbol according to ISO/DIS11898-2:2023 at the terminal TXD. The predetermined PWM symbol signals that the transmitting/receiving device 120 must switch from the operating mode SIC, in which signals according to FIG. 12 are transmitted onto the bus 40 in the arbitration phase 451, to the operating mode FAST RX or the operating mode FAST_TX, in which signals according to the right part of FIG. 9 are transmitted onto the bus 40 in the data phase 452.

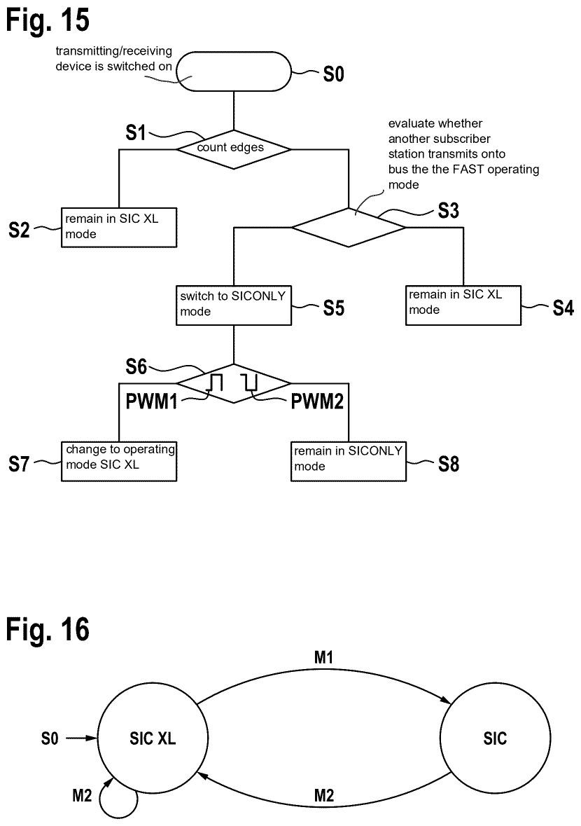

For this purpose, the transmitting/receiving device 120 can proceed, for example, according to FIG. 15. Up to step S5, FIG. 15 is identical to FIG. 13.

Accordingly, after step S5, the transmitting/receiving device 120 in FIG. 15 proceeds to step S6.

In step S6, the transmitting/receiving device 120, in particular the transmission signal evaluation block 1224C, checks whether the signal TxD INT contains a first PWM symbol, for example a symbol PWM1, or a second PWM symbol, for example a symbol PWM2. For example, the symbol PWM1 encodes a bit with the value HI or 1 in the signal TxD INT. For example, the symbol PWM2 encodes a bit with the value LW or 0 in the signal TxD INT. If one of the symbols PWM1, PWM2 is present in the signal TxD INT, the flow proceeds to step S7. If none of the symbols PWM1, PWM2 is present in the signal TxD INT, the flow proceeds to step S8.

In step S7, the transmitting/receiving device 120 changes to the operating mode SIC XL. In particular, the change can be carried out in response to signaling by means of the signal S_BW to the operating mode control module 123. The transmitting/receiving device 12 of FIG. 4 is thus set as described above for step S2 or S4 of FIG. 13 and may accordingly transmit or receive CAN XL frames 460.

In step S8, the transmitting/receiving device 120 remains in the SICONLY mode and stops counting by means of the counting block 1224A and evaluating by means of the evaluation block 1224B. The transmitting/receiving device 12 of FIG. 4 is thus set for transmitting and receiving signals from the bus 40, as described above for step S5 of FIG. 13.

The above-described function of the transmitting/receiving device 120, in particular its transmission signal evaluation block 1224C, increases functional safety. This is because any incorrect decision of the logic circuit 1224 made based on a result of the counting block 1224A is compensated for by the transmission signal evaluation block 1224C.

That is to say, if the evaluation of the transmitting/receiving device 12 according to the first exemplary embodiment has come to an incorrect decision (change to SICONLY mode) for inexplicable reasons, the evaluation by means of the transmission signal evaluation block 1224C switches back to the operating mode SIC XL at the first frame 460 to be transmitted or received.

The function or result of the evaluation of the transmitting/receiving device 12 by means of the counting block 1224A according to the first exemplary embodiment (mechanism M1) is thus overwritten by the function or result of the evaluation of the transmission signal evaluation block 1224C (mechanism M2).

FIG. 16 illustrates the change between the states in which the transmitting/receiving device 120 is switched to the SIC XL mode or the SICONLY mode, which is shown as operating mode SIC. After switching on the transmitting/receiving device 12 or 120 in step S0, switching to the SIC XL mode or the operating mode SIC or XL is carried out. Subsequently, the mechanism M1 can switch the transmitting/receiving device 12 or 120 to the SICONLY mode, as the operating mode SIC for the phases 451, 452. The mechanism M2 can switch the transmitting/receiving device 120 from SICONLY mode or the operating mode SIC back to the SIC XL mode. In addition, if the transmitting/receiving device 120 has already been switched to the SIC XL mode, the mechanism M2 holds the transmitting/receiving device 120 in the SIC XL mode.

In all other respects, the same applies as described with respect to the first exemplary embodiment.

According to a third exemplary embodiment, the transmitting/receiving device 120 of FIG. 14 is configured to deactivate the mechanism M1 until the transmitting/receiving device 120 is switched on again. The transmitting/receiving device 120 may be switched on again in step S0 of FIG. 15, for example after the transmitting/receiving device 120 has been switched off.

This can reduce the power input into the transmitting/receiving device 12.

According to a fourth exemplary embodiment, at least one of the transmitting/receiving devices 12, 120 of the above-described exemplary embodiments is configured to select the predetermined number N to be greater than 20. For example, N=25. As a result of selecting the predetermined number N such, i.e., to be large, detection of the SICONLY mode or the operating mode SIC on bus 40 could take longer than the duration for one of the frames 450, 460. For example, the detection of the mode or the operating mode may correspond to a duration that is 2 frames 450, 460 long. The number of edges in the frames 450, 460 depends on the data being transmitted.

The detection of the mode or the operating mode thus takes longer than in the above-described exemplary embodiments. However, as a result, correct detection of the operating mode in the bus system 1 by means of the transmitting/receiving device in the present exemplary embodiment is carried out even if a noisy environment is present. In such a noisy environment, DPI/ISO pulses that result in additional pulses on the internal reception signal RXD_INT may occur.

As a result, the transmitting/receiving device 12 of FIG. 4 or the transmitting/receiving device 120 of FIG. 14 in the present exemplary embodiment is more robust against interference than in the above-described exemplary embodiments.

According to a fifth exemplary embodiment, at least one of the transmitting/receiving devices 12, 120 of the above-described exemplary embodiments is configured to check a minimum pulse time or pulse length in the internal reception signal RXD_INT in addition to the predetermined number N of the edges. The minimum pulse time in the internal reception signal RXD_INT is checked for a pulse between a rising and the next subsequent falling edge or a pulse between a falling edge and the next subsequent rising edge.

Accordingly, if falling edges are to be counted, the falling edge is only counted if the pulse generating the edge has a predetermined minimum duration. For example, the minimum duration may be any fraction or multiple of a bit time t_bt1 or t_bt2, for example 100 ns. The highest_bit rate in the SICONLY mode is a bit rate of 8 Mbit/s. This results in a minimum bit duration t_bt2 of 125 ns per bit.

This option makes it possible for the transmitting/receiving device 12, 120 of the above-described exemplary embodiments to be operated reliably even in noisy environments (DPI/ISO pulses), in which interference results in additional pulses on the RXD_INT signal, which are short in duration in comparison to the bits during communication so that communication on the bus 40 is possible.

This increases the robustness against interference. In addition, it is possible to complete detection of the operating mode on the bus 40 in the first frame 450, 460 seen and to switch the transmitting/receiving device 12, 120 of the above-described exemplary embodiments accordingly.

According to a sixth exemplary embodiment, at least one of the transmitting/receiving devices 12, 120 of the above-described exemplary embodiments is configured to check a minimum interval between two pulses in the internal reception signal RXD_INT in addition to the predetermined number N of the edges. For this purpose, pulses that_begin with a rising edge and end with the next subsequent falling edge are checked in the internal reception signal RXD_INT. Alternatively, pulses that_begin with a falling edge and end with the next subsequent rising edge are checked for this purpose.

Accordingly, if two pulses follow each other too quickly so that the minimum interval between these two pulses is not given, the second pulse is not counted. For example, the minimum interval may be any multiple or fraction of a bit time t_bt1 or t_bt2, for example 100 ns. The highest_bit rate in the SICONLY mode or the operating mode SIC is a bit rate of 8 Mbit/s. This results in a minimum bit time t_bt2 of 125 ns per bit.

This option makes it possible for the transmitting/receiving device 12, 120 of the above-described exemplary embodiments to be operated reliably even in noisy environments (DPI/ISO pulses), in which interference results in additional pulses on the RXD_INT signal, which quickly follow one another in comparison to the bits during communication.

This also increases the robustness against interference. In addition, it is possible to complete detection of the operating mode on the bus 40 in the first frame 450, 460 seen and to switch the transmitting/receiving device 12, 120 of the above-described exemplary embodiments accordingly.

All of the above-described embodiments of the subscriber stations 10, 20, 30, of the bus system 1, and of the method carried out therein can be used alone or in all possible combinations. In particular, all features of the above-described exemplary embodiments and/or their modifications can be combined as desired. Additionally, or alternatively, the following modifications in particular are possible.

Even if the present invention is described above using the example of the CAN bus system, the present invention can be used in any communication network and/or communication method in which two different communication phases are used in which the bus states generated for the different communication phases can be different.

In particular, the bus system 1 according to the exemplary embodiments can be a communication network in which data can be transmitted serially at two different bit rates. It is advantageous, but not necessarily a prerequisite, that exclusive, collision-free access of a subscriber station 10, 20, 30 to a common channel is ensured in the bus system 1 at least for specific periods of time.

The number and arrangement of the subscriber stations 10, 20, 30 in the bus system 1 of the exemplary embodiments is arbitrary. It is possible for one or more of the subscriber stations 10 to be present in the bus system 1. It is possible for more than one subscriber station 20 to be present in the bus system 1.

In particular, only subscriber stations 10 are present.

What is claimed is:

1. A transmitting/receiving device for a subscriber station of a serial bus system, comprising:
a receiver module configured to serially receive differential signals from a bus of the bus system and to generate a digital reception signal for a communication control device;
an operating mode control module configured to switch the receiver module between a first operating mode and a second operating mode so that the receiver module is configured to generate the digital reception signal in the first operating mode based on differential signals generated using a first physical layer and in the second operating mode based on differential signals generated using a second physical layer, which is different from the first physical layer; and
a first evaluation block configured to evaluate whether a predetermined number of falling edges and/or rising edges occurs serially in the digital reception signal and whether the reception signal that includes the edges that occurred is based on differential signals generated using the second physical layer;
wherein the operating mode control module is also configured to set the transmitting/receiving device for a subsequent operation of the transmitting/receiving device based on a result of the evaluation of the first evaluation block.

2. The transmitting/receiving device according to claim 1, wherein the operating mode control module is also configured to set the receiver module for a subsequent operation of the receiver module based on the evaluation result of the first evaluation block such that, regardless of a change of communication phases of the differential signals for a message on the bus, the receiver module remains switched to the first operating mode and is not switched to the second operating mode, and a receiver circuit of the receiver module is switched off, the receiver circuit_being configured for evaluating the differential signals with a lower reception threshold than a reception threshold used by a receiver circuit of the receiver module for generating the reception signal.

3. The transmitting/receiving device according to claim 1, wherein the operating mode control module is configured to switch the transmitting/receiving device for a subsequent operation of the transmitting/receiving device, to the first operating mode if the predetermined number of falling edges and/or rising edges occurs and the digital reception signal that includes the edges that occurred is based on differential signals not generated using the second physical layer.

4. The transmitting/receiving device according to claim 1, wherein the operating mode control module is configured to, if a number less than or equal to the predetermined number of falling edges and/or rising edges occurs and/or the digital reception signal that includes the edges that occurred is based on differential signals generated using the second physical layer, set the transmitting/receiving device for a subsequent operation of the transmitting/receiving device, such that the operating mode control module switches from the first operating mode to the second operating mode if, in a message transmitted via the bus using the differential signals, a change from a first communication phase to a second communication phase of the message is signaled by switching the physical layer.

5. The transmitting/receiving device according to claim 1, wherein:
the first evaluation block is configured to evaluate whether the predetermined number of falling edges or rising edges occurs serially in the digital reception signal, and
the predetermined number is a natural number and is in a range of N=12 to N=20.

6. The transmitting/receiving device according to claim 1, wherein:
the first evaluation block is configured to evaluate whether the predetermined number of falling edges and rising edges occurs serially in the digital reception signal, and
the predetermined number is a natural number and is in a range of N=30 to N=40.

7. The transmitting/receiving device according to claim 1, wherein the first evaluation block is also configured to evaluate, in the reception signal, the pulse time of pulses delimited by a rising flank and a falling flank or delimited by a falling flank and a rising flank.

8. The transmitting/receiving device according to claim 1, wherein the first evaluation block is configured to count edges in the reception signal for the predetermined number only if pulses: (i) delimited by a rising flank and a falling flank, or (ii) delimited by a falling flank and a rising flank, have a minimum pulse time.

9. The transmitting/receiving device according to claim 1, wherein the first evaluation block is also configured to evaluate, in the reception signal, the interval between pulses: (i) delimited by a rising flank and a falling flank, or (ii) delimited by a falling flank and a rising flank.

10. The transmitting/receiving device according to claim 9, wherein the first evaluation block is configured to count edges in the reception signal for the predetermined number only if the reception signal contains a minimum interval between two pulses: (i) delimited by a rising flank and a falling flank, or (ii) delimited by a falling flank and a rising flank.

11. The transmitting/receiving device according to claim 1, wherein:
the first evaluation block performs its evaluation if the receiver module is switched to the first operating mode and the transmitting/receiving device has also been switched on again or attempts after an error to integrate into the communication on the bus, and
a receiver circuit configured to receive the differential signals generated using the second physical layer is switched off after the operating mode control module has set the receiver module for a subsequent operation of the receiving module based on the evaluation result of the first evaluation block.

12. The transmitting/receiving device according to claim 1, further comprising:
a transmitter module configured to serially transmit onto the bus the differential signals based on a digital transmission signal generated by a communication control device, wherein the transmission signal can have a first bit time in a first communication phase and a second bit time, which is shorter than the first_bit time, in a second communication phase;
wherein the transmitter module is settable to transmit the differential signals onto the bus in the second communication phase using the first physical layer or the second physical layer.

13. The transmitting/receiving device according to claim 1, further comprising:
a second evaluation block configured to evaluate the transmission signal with respect to an occurrence of pulse-width-modulated symbols;
wherein the operating mode control module is configured to set the receiver module for a subsequent operation of the receiver module, based on the evaluation result of the first evaluation block.

14. The transmitting/receiving device according to claim 13, wherein the operating mode control module is configured to switch the receiver module for a subsequent operation of the receiver module to the second operating mode if the second evaluation block has evaluated that at least one pulse-width-modulated symbol has occurred in the transmission signal.

15. A subscriber station for a serial bus system, comprising:
a transmitting/receiving device including:
a receiver module configured to serially receive differential signals from a bus of the bus system and to generate a digital reception signal for a communication control device,
an operating mode control module configured to switch the receiver module between a first operating mode and a second operating mode so that the receiver module is configured to generate the digital reception signal in the first operating mode based on differential signals generated using a first physical layer and in the second operating mode based on differential signals generated using a second physical layer, which is different from the first physical layer, and
a first evaluation block configured to evaluate whether a predetermined number of falling edges and/or rising edges occurs serially in the digital reception signal and whether the reception signal that includes the edges that occurred is based on differential signals generated using the second physical layer,
wherein the operating mode control module is also configured to set the transmitting/receiving device for a subsequent operation of the transmitting/receiving device based on a result of the evaluation of the first evaluation block; and
the communication control device, the communication control device configured, in a first communication phase of a frame for a message to be transmitted on the bus, to negotiate with at least one other subscriber station of the bus system as to which of the subscriber stations gains at least temporarily exclusive, conflict-free access to the bus in a subsequent second communication phase.

16. A bus system, comprising:
a bus; and
at least two subscriber stations connected to one another such that they can communicate serially with one another,
wherein at least one of the at least two subscriber stations is configured for communication according to CAN XL, and includes:
a transmitting/receiving device including:
a receiver module configured to serially receive differential signals from a bus of the bus system and to generate a digital reception signal for a communication control device,
an operating mode control module configured to switch the receiver module between a first operating mode and a second operating mode so that the receiver module is configured to generate the digital reception signal in the first operating mode based on differential signals generated using a first physical layer and in the second operating mode based on differential signals generated using a second physical layer, which is different from the first physical layer, and
a first evaluation block configured to evaluate whether a predetermined number of falling edges and/or rising edges occurs serially in the digital reception signal and whether the reception signal that includes the edges that occurred is based on differential signals generated using the second physical layer,
wherein the operating mode control module is also configured to set the transmitting/receiving device for a subsequent operation of the transmitting/receiving device based on a result of the evaluation of the first evaluation block;
and
the communication control device, the communication control device configured, in a first communication phase of a frame for a message to be transmitted on the bus, to negotiate with at least one other subscriber station of the bus system as to which of the subscriber stations gains at least temporarily exclusive, conflict-free access to the bus in a subsequent second communication phase.

17. A method for communicating using differential signals in a serial bus system, wherein the method is carried out using a transmitting/receiving device for a subscriber station of a serial bus system, wherein the transmitting/receiving device includes a receiver module, an operating mode control module, and a first evaluation block, and wherein the method comprises the following steps:
serially receiving, using the receiver module, differential signals from a bus of the bus system for generating a digital reception signal for the communication control device, wherein the receiver module is switchable between a first operating mode and a second operating mode using the operating mode control module so that the receiver module is configured to generate the digital reception signal in the first operating mode based on differential signals generated using a first physical layer and in the second operating mode based on differential signals generated using a second physical layer, which is different from the first physical layer;
evaluating, using the first evaluation block, whether a predetermined number of falling edges and/or rising edges occurs serially in the digital reception signal and whether the reception signal that includes the edges that occurred is based on differential signals generated using the second physical layer; and
setting, using the operating mode control module, the transmitting/receiving device for a subsequent operation of the transmitting/receiving device, based on a result of the evaluation of the first evaluation block.
